(19) United States
(12) Patent Application Publication
(10) Pub. No.: US 2023/0063605 A1
(43) Pub. Date: Mar. 2, 2023

(54) LOCKING PLIERS WITH INDICATORY ADJUSTMENT DEVICE

(71) Applicant: Ming Chieh WU, Taichung City (TW)

(72) Inventor: Ming Chieh WU, Taichung City (TW)

(21) Appl. No.: 17/585,757

(22) Filed: Jan. 27, 2022

(30) Foreign Application Priority Data
Aug. 27, 2021 (TW) 110210132

(51) Int. Cl. B25B 7/02; B25B 7/12

(52) U.S. Cl. CPC B25B 7/02; B25B 7/123

(57) ABSTRACT

A pair of locking pliers with an indicatable adjustment device includes a main body which includes a first and a second gripping jaw cooperatively for clamping a workpiece and an indicatory adjustment device configured to fine tune the clamping pressure between the first and the second gripping jaws and having an auxiliary sign which shows different indications in response to the operation of the adjustment device.

### BACKGROUND OF THE INVENTION

### 1. Field of the Invention

The present invention relates to a locking pliers and, particularly, to an adjustment device of the locking pliers which is indicatory.

### 2. Description of the Related Art

TW Pat. No. M449066 discloses a pair of locking pliers with a multifunctional adjustment device. The pair of locking pliers includes a fixed jaw, a movable jaw pivotally connected with the fixed jaw, a locking device connected with the fixed and the movable jaws, and an adjustment device connected with the locking device. The locking device includes a limiting body pivotally connected with the movable jaw. The adjustment device includes a screw threadly connected with the fixed clamp and an adjustment button connected with the screw. The adjustment button has a main operational body and an auxiliary operational body. The main body has an outer periphery including a groove. The auxiliary operational body is polygonal. The main function of the adjustment button is to adjust the clamping force of the pair of locking pliers. Moving the adjustment button in a first direction can increase the clamping force, while moving the adjusting bottom in a second direction can decrease the clamping force.

Generally, a user has to make repeated attempts to tweak the adjustment button for a desirable clamping force. However, this is troublesome.

The present invention is, therefore, intended to obviate or at least alleviate the problems encountered in the prior art.

### SUMMARY OF THE INVENTION

According to the present invention, a pair of locking pliers with an indicatable adjustment device includes a main body including a first and a second gripping jaw cooperatively for clamping a workpiece and an indicatory adjustment device configured to fine tune the clamping pressure between the first and the second gripping jaws and having an auxiliary sign which shows different indications in response to the operation of the adjustment device. The adjustment device is in a shape having a first section and a second section. The first section is coupled to the main body to connect the adjustment device with the main body. The second section has two opposite surfaces and the first section extends from a first of the two opposite surfaces. The auxiliary sign is at an end and located on a second of the two opposite surfaces. The auxiliary sign does not have point symmetry about an axis of rotation of the adjustment device. The auxiliary sign is located offset to the axis of the rotation of the adjustment device.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing other structures, methods and systems for carrying out the several purposes of the present invention. It is important, therefore, that the claims be regarded as including such equivalent constructions insofar as they do not depart from the spirit and scope of the present invention.

Further, the purpose of the abstract is to enable the public generally, and especially scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view of a pair of locking pliers with an indicatable adjustment device in accordance with the present invention.

FIG. 2 is a side view of the pair of locking pliers of FIG. 1, with a sign on an adjustment device of the pair of locking pliers in a first orientation.

FIG. 3 is another side view of the pair of locking pliers of FIG. 1, with the sign on the adjustment device in a second orientation.

FIG. 4 is another side view of the pair of locking pliers of FIG. 1, with the sign on the adjustment device in a third orientation.

### DETAILED DESCRIPTION OF THE INVENTION

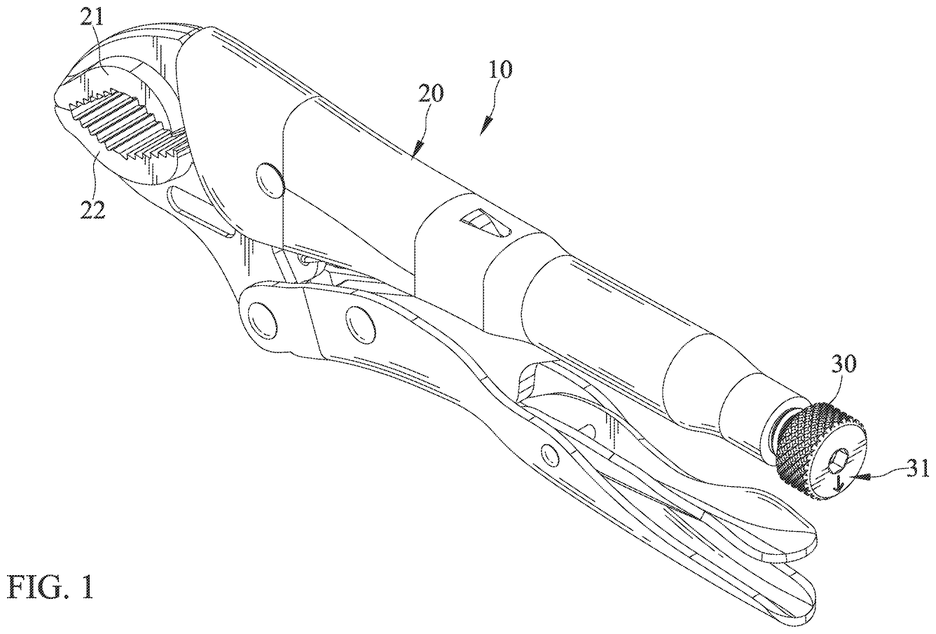

FIGS. 1 through 4 show a pair of locking plier 10 with an indicatable adjustment device in accordance with the present invention. The locking pliers 10 includes a main body 20 including a first and a second gripping jaw 21 and 22 cooperatively for clamping a workpiece.

Moreover, the locking pliers 10 includes an indicatory adjustment device 30 configured to fine tune the clamping pressure between the first and the second gripping jaws 21 and 22. The adjustment device 30 is rotatably connected with the main body 20. The adjustment device 30 is indicatory in that it has an auxiliary sign 31 which shows different indications in response to the operation of the adjustment device 30. The adjustment device 30 is in a shape having a first section in a form of a shaft and a second section in a form of a head. The first section is coupled to the main body 20 to connect the adjustment device 30 with the main body 20. The head has a larger radius than the shaft. The second section of the adjustment device 30 has a knurled circumference. Moreover, the second section of the adjustment device 30 has two opposite surfaces and the first section extends from the a first of the two opposite surfaces, and the auxiliary sign 31 is at an end and located on a second of the two opposite surfaces of the second section of the adjustment device 30.

The auxiliary sign 31 does not have point symmetry about an axis of rotation of the adjustment device 30. The auxiliary sign 31 is located offset to the axis of the rotation of the adjustment device 30. The auxiliary sign 31 has a first section 311 extending radially to the axis of the rotation of the adjustment device 30. The auxiliary sign 31 also has a second section 312 and a third section 313 extending oppositely from the first section 311. The second and the third sections 312 and 313 are inclined to the first section 311. The second section 312 extending inclinedly and the third section 313 extending inclinedly. The second and the third sections 312 and 313 cooperate to form a shape of letter v. The second section 312 and the third section 313 have an included angle therebetween, which is acute. The second and the third sections 312 and 313 are shorter than the first section 311 in length. The first and the second sections 311 and 312 have a first included angle less than 60 degrees. The first and the third sections 311 and 313 have a second included angle less than 60 degrees. The second section 312 has a longitudinal length less than 0.5 times a longitudinal length of the first section 311. The third section 313 has a longitudinal length less than 0.5 times a longitudinal length of the first section 311.

Generally, the method of using the locking pliers 10 to clamp a workpiece includes closing the first and the second gripping jaws 21 and 22, and then rotating the adjustment device 30 until the first gripping jaw 21 and the second gripping jaw 22 are in contact with the workpiece.

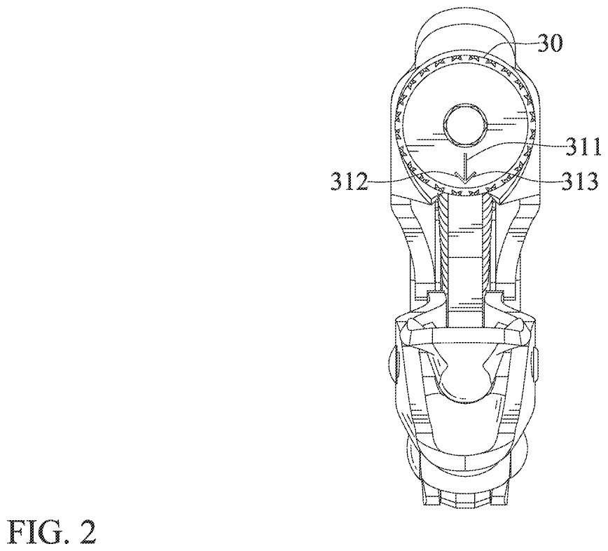

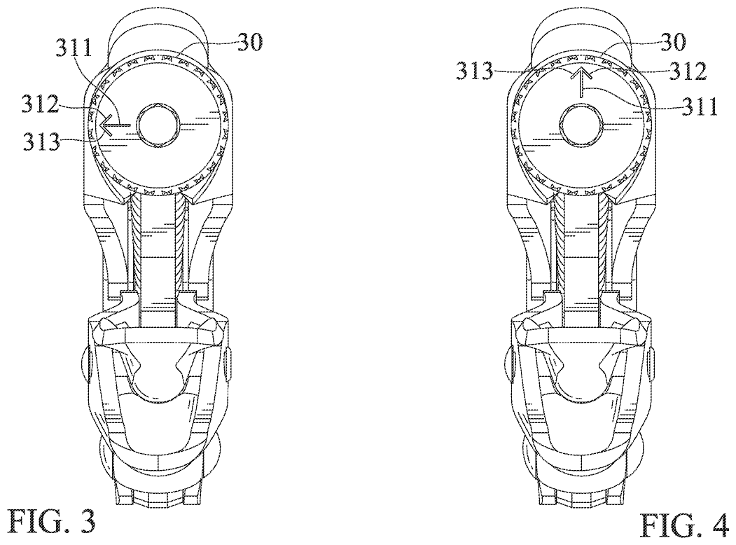

In view of the foregoing, the adjusting device 30 can be operated to make the first gripping jaw 21 and the second gripping jaw 22 approach or move away from each other. The indicatable adjustment device 30 of the locking pliers 10 enables a user to control the degree of clamping. Here, the user can know the rotation angle of the adjustment device 30 from the auxiliary sign 31. For example, if the adjustment device 30 is rotated 90 degrees from a first orientation (FIG. 2) to a second orientation (FIG. 3), the locking pliers 10 clamps the workpiece with a light clamping force, and if the adjustment device 30 is tightened 180 degrees from the first orientation (FIG. 2) to a third orientation (FIG. 4), a heavier clamping force is applied to clamp the workpiece.

The foregoing is merely illustrative of the principles of this invention and various modifications can be made by those skilled in the art without departing from the scope and spirit of the invention.

What is claimed is:

1. A pair of locking pliers with an indicatable adjustment device comprising:
a main body including a first and a second gripping jaw cooperatively for clamping a workpiece; and
an indicatory adjustment device configured to fine tune the clamping pressure between the first and the second gripping jaws and having an auxiliary sign which shows different indications in response to the operation of the adjustment device
wherein the adjustment device is in a shape having a first section and a second section, wherein the first section is coupled to the main body to connect the adjustment device with the main body, wherein the second section has two opposite surfaces and the first section extends from a first of the two opposite surfaces, wherein the auxiliary sign is at an end and located on a second of the two opposite surfaces, wherein the auxiliary sign does not have point symmetry about an axis of rotation of the adjustment device, and wherein the auxiliary sign is located offset to the axis of the rotation of the adjustment device.

2. The locking pliers as claimed in claim 1, wherein the auxiliary sign has a first section extending radially to the axis of the rotation of the adjustment device.

3. The locking pliers as claimed in claim 1, wherein the auxiliary sign has one section extending inclinedly and another section extending inclinedly, and wherein the one and another sections have an included angle therebetween.

4. The locking pliers as claimed in claim 2, wherein the auxiliary sign has a second section and a third section extending oppositely from the first section.

5. The locking pliers as claimed in claim 4, wherein the second and the third sections are inclined to the first section, and wherein the second and the third sections are shorter than the first section in length.

6. The locking pliers as claimed in claim 5, wherein the first and the second sections have a first included angle less than 60 degrees, wherein the first and the third sections have a second included angle less than 60 degrees, wherein the second section has a longitudinal length less than 0.5 times a longitudinal length of the first section, and wherein the third section has a longitudinal length less than 0.5 times a longitudinal length of the first section.

7. The locking pliers are claimed in claim 1, wherein the second section has a larger radius than the first section.

8. The locking pliers as claimed in claim 3, wherein the included angle is acute and the one and another sections cooperate to form a shape of letter v.
